(19) United States
(12) Patent Application Publication
(10) Pub. No.: US 2024/0322390 A1
(43) Pub. Date: Sep. 26, 2024

(54) BATTERY PACK

(71) Applicant: SAMSUNG SDI CO., LTD., Yongin-si, Gyeonggi-do (KR)

(72) Inventors: Mansik CHO, Yongin-si, Gyeonggi-do (KR); Jaemin KIM, Yongin-si, Gyeonggi-do (KR); Shidong PARK, Yongin-si, Gyeonggi-do (KR); Jangwoong BAE, Yongin-si, Gyeonggi-do (KR)

(21) Appl. No.: 18/616,448

(22) Filed: Mar. 26, 2024

(30) Foreign Application Priority Data
Mar. 26, 2023 (KR) 10-2023-0039398
Feb. 22, 2024 (KR) 10-2024-0026042

(51) Int. Cl. H01M 50/507; H01M 10/6554; H01M 50/204; H01M 50/503

(52) U.S. Cl. CPC H01M 50/507; H01M 10/6554; H01M 50/503; H01M 50/204

(57) ABSTRACT

A battery pack is disclosed. The battery pack includes a plurality of battery cells arranged in a first direction, each including a pair of main surfaces arranged to face each other in the first direction. Each of the battery cells also includes upper and lower surfaces forming a pair of long sides facing each other, and first and second side surfaces forming a pair of short sides facing each other. First and second bus bars electrically connect the plurality of battery cells to each other in an alternating manner such that battery cells adjacent to each other in the first direction are not electrically connected by the first and second bus bars. A third bus bar electrically connects first and second output terminals formed together on a front side of the plurality of battery cells in the first direction, and the third bus bar electrically connects adjacent battery cells to each other at a rear side of the plurality of the battery cells. The battery pack may be easily electrically connected to a set device, has a simplified structured with improved electrical output, may eliminate interference between a cooling structure and an electrical connection structure, and is advantageously slim.

### CROSS-REFERENCE TO RELATED APPLICATION

The present application claims priority and the benefit of Korean Patent Application Nos. 10-2023-0039398, filed on Mar. 26, 2023, and 10-2024-0026042, filed on Feb. 22, 2024, in the Korean Intellectual Property Office, the entire disclosures of which are incorporated herein by reference.

### BACKGROUND

### 1. Field

One or more embodiments relate to a battery pack.

### 2. Description of the Related Art

Generally, secondary batteries are chargeable and dischargeable unlike primary batteries that cannot be recharged. Secondary batteries are used as an energy source for mobile devices, electric vehicles, hybrid vehicles, electric bicycles, and uninterruptible power supplies. Depending on the type of external devices to which they are applied, secondary batteries may be used in the form of a single battery or a module in which batteries are connected and bundled into one unit.

Small mobile devices, such as mobile phones, may operate for a certain period of time with an output and capacity of a single battery. However, when a long-term operation or high-power operation is required, such as in the case of electric vehicles or hybrid vehicles that consume a lot of power, a module type including multiple batteries is preferred because of output and capacity issues, and an output voltage or output current may be increased with the number of built-in batteries.

### SUMMARY

One or more embodiments include a battery pack including output terminals that have different polarities and are formed at adjacent positions to each other so that an electrical connection to a set device is easily achieved.

One or more embodiments include a battery pack that has improved electrical output due to shortening of an electrical path of an output terminal, improved space utilization through a simplified structure, and is robust against external vibrations and shocks.

One or more embodiments include a battery pack that may eliminate physical and electrical interference between a cooling structure of battery cells and an electrical connection of the battery cells due to arrangement of a cooling plate for cooling the battery cells and a bus bar for electrically connecting the battery cells on a long side and short side of the battery cells facing each other along an intersecting direction.

One or more embodiments include a battery pack that may increase a cooling area by disposing cooling plates on the upper and lower surfaces of the long side and the short side of the battery cells, may avoid placing a burden on the short side forming the height dimension by arranging electrical connections on the first and second side surfaces forming the short sides that are relatively short, and is advantageously slim.

Additional aspects will be set forth in part in the description which follows and, in part, will be apparent from the description, or may be learned by practice of the presented embodiments of the present disclosure.

According to one or more embodiments, a battery pack includes a plurality of battery cells arranged in a first direction, each battery cell including (i) a pair of main surfaces arranged to face each other in the first direction, (ii) upper and lower surfaces forming a pair of long sides facing each other, and (iii) first and second side surfaces forming a pair of short sides facing each other, with the upper and lower surfaces and the first and second side surfaces connecting the main surfaces to each other, first and second bus bars electrically connecting battery cells of the plurality of battery cells to each other in an alternating manner such that adjacent battery cells in the first direction are not electrically connected to each other by the first and second bus bars, and first and second output terminals formed together on a first side of the plurality of battery cells in the first direction and a third bus bar that electrically connects adjacent battery cells to each other at a second side of the plurality of the battery cells that is opposite to the first side.

For example, the first and second output terminals draw from first and second battery cells arranged adjacent to each other at the first side of the plurality of battery cells, and the third bus bar may connect an n−1^{th} battery cell and an n^{th} battery cell positioned adjacent to each other at the second side of the plurality of battery cells, with n being an integer greater than 1.

For example, the battery pack may further include an upper cooling plate and a lower cooling plate respectively positioned on the upper and lower surfaces, respectively, forming the long sides of the plurality of battery cells.

For example, the upper and lower surfaces of each battery cell may face each other in a second direction that intersects the first direction, and the first and second side surfaces of the battery cell may face each other in a third direction that intersects the first and second directions.

For example, the first bus bar includes a plurality of first bus bars and the second bus bar includes a plurality of second bus bars, the plurality of first bus bars electrically connect non-adjacent battery cells to each other on first side surfaces of the plurality of battery cells, and the plurality of second bus bars electrically connecting non-adjacent battery cells to each other on second side surfaces of the plurality of battery cells, wherein the plurality of first bus bars may include a 1st-1 bus bar and a 2nd-1 bus bar that connects non-adjacent battery cells to each other while bypassing an upper position adjacent to the upper surfaces so as not to cause a short-circuit to each other, and wherein the plurality of second bus bars includes a 1 st-2 bus bar and a 2nd-2 bus bar that connects non-adjacent battery cells to each other while bypassing a lower position relatively adjacent to the lower surfaces of the battery cells so as not to cause a short-circuit to each other.

For example, the 1st-1 bus bar and the 1st-2 bus bar may be arranged to engage to interlock with each other on the first side surfaces of the battery cells and connect the battery cells that are not adjacent to each other without short circuiting by detouring the upper positions and the lower positions, respectively, and wherein the 2nd-1 bus bar and the 2nd-2 bus bar may be arranged to interlock with each other on the second side surfaces of the battery cells and the battery cells that are not adjacent to each other without short circuiting by detouring the upper positions and the lower positions, respectively.

For example, the 1st-1 bus bar may include a 1st-1 connection unit extending in the first direction at the upper positions of the battery cells and a pair of 1st-1 branch portions extending from both ends of the 1 st-1 connection unit toward the lower positions of the battery cells and connected to electrode terminals of the battery cells that are not adjacent to each other, and wherein the 1 st-2 bus bar may include a 1 st-2 connection unit extending in the first direction at the lower positions of the battery cells and a pair of 1st-2 branch portions extending from both ends of the 1 st-2 connection unit toward the upper positions of the battery cells and connected to electrode terminals of the battery cells that are not adjacent to each other.

For example, the 2nd-1 bus bar may include a 2nd-1 connection portion extending along a first direction at upper positions of the battery cells, and a pair of 2nd-1 branch portions extending from both ends of the 2nd-1 connection portion toward lower positions of the battery cells and connected to electrode terminals of the battery cells that are not adjacent to each other, and wherein the 2nd-2 bus bar may include a 2nd-2 connection unit extending in the first direction at the lower positions of the battery cells, and a pair of 2nd-2 branch portions extending from both ends of the 2nd-2 connection unit toward the upper positions of the battery cells and connected to electrode terminals of the battery cells that are not adjacent to each other.

For example, the third bus bar may extend to surround a rear end plate disposed at a rear position at the second side of the plurality of battery cells, and the third bus bar is bent so as to extend along the first and second side surfaces of the n−1^{th} battery cell and the n^{th} battery cell adjacent to each other at the rear position.

For example, the third bus bar may connect the n−1^{th} battery cell and the n^{th} battery cell that are adjacent to each other at the rear position via a rear connection bar.

For example, the rear connection bar may include a first portion extending in the first direction in which the third bus bar extends at upper positions on the first and second side surfaces of the n−1^{th} battery cell and the n^{th} battery cell, and a second portion extending from the first portion toward lower positions on the first and second side surfaces of the n−1^{th} battery cell and the n^{th} battery cell and connected to electrode terminals of the n−1^{th} battery cell and the n^{th} battery cell.

For example, the battery pack may further include first and second terminal connection members each including ends forming the first and second output terminals at a front-end plate disposed at the front position at the first side of the plurality of battery cells, the first and second terminal connection members extending in the first direction from ends connected to an electrode terminal of a first battery cell and an electrode terminal of a second battery cell, respectively, that are arranged adjacent to each other at the front position among the plurality of battery cells.

For example, the first and second terminal connection members are connected by a front connection bar to the first and second battery cells arranged adjacent to each other in the front position.

For example, the front connecting bar may include a first portion extending in the first direction in which the first and second terminal connection members extend at upper positions on first and second side surfaces of the first and second battery cells, and a second portion extending from the first portion toward a lower position and connected to the electrode terminals of the first and second battery cells.

For example, a connection portion of the 1 st-1 bus bar and a connection portion of the 2nd-1 bus bar extend across upper positions of the first and second bus bars, a first portion of a rear connection bar connected to the third bus bar, and a first portion of first and second terminal connecting members including the first and second output terminals may be disposed at upper positions of the same level in the second direction.

For example, a connection portion of the 1 st-2 bus bar a connection portion of the 2nd-2 bus bar extend across lower positions of the first and second bus bars and may be disposed at lower positions of the same level in the second direction.

For example, the first and second bus bars may be positioned on a pair of side plates extending across the first and second side surfaces of the plurality of battery cells, the side plates covering the first and second side surfaces of the plurality of battery cells, and the first and second bus bars are electrically connected to electrode terminals of the plurality of battery cells, with the electrode terminals being exposed through the first and second terminal holes formed in the side plates.

For example, the battery pack may further include cover pieces in the first and second terminal holes to close a portion of the first and second terminal holes.

For example, the cover pieces may block the first bus bar and the second bus bar electrically connecting a pair of battery cells of the plurality of battery cells that are matched to each other on the first and second side surfaces of the pair of battery cells from being erroneously connected to a battery cell interposed between the pair of the battery cells.

For example, a connection portion of the 1 st-1 bus bar and a connection portion of the 2nd-1 bus bar extend across upper positions of the first and second bus bars, a first portion of a rear connection bar is connected to the third bus bar, and a first portion of the first and second terminal connection members includes the first and second output terminals, and the first and second terminal connection members may be disposed at an upper position, the connection portion of the 1 st-2 bus bar and the connection portion of the 2nd-2 bus bar extend across lower positions among the first and second bus bars and may be disposed at a lower position in the second direction, and cover pieces may be formed on a lower portion first and second terminal holes, with the cover pieces extending across the connection portion of the 1 st-2 bus bar and the connection portion of the 2nd-2 bus bar.

For example, the 1st-1 bus bar and the 2nd-1 bus bar may include a 1st-1 connection unit and a 2nd-1 connection unit, respectively, positioned on side plates, the 1 st-1 bus bar and the 2nd-1 bus bar include a pair of 1 st-1 branch portions and a pair of 2nd-1 branch portions, respectively, that are connected to electrode terminals extended from the 1st-1 connection unit and the 2nd-1 connection unit, respectively, the pair of 1 st-1 branch portions and the pair of 2nd-1 branch portions are exposed to outside of the side plates through first and second terminal holes of the side plates, and the pair of 1st-1 branch portions and the pair of 2nd-1 branch portions are formed to be stepwise outward from the 1st-1 connection unit and the 2^{nd}-1 connection unit, respectively, and wherein the 1 st-2 bus bar and the 2nd-2 bus bar include a pair of 1 st-2 branch portions and a pair of 2nd-2 branch portions, respectively, connected to the electrode terminals exposed to the outside of the side plates through the first and second terminal holes of the side plates, and a 1 st-2 connection unit and a 2nd-2 connection unit connect the pair of 1st-2 branch portions and the pair of 2nd-2 branch portions to each other, respectively, and the 1st-2 connection unit and the 2nd-2 connection unit are formed to be stepwise outward from the pair of 1st-2 branch portions or the pair of 2nd-2 branch portions, respectively, to accommodate cover pieces.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view of a battery pack viewed from a front side, according to embodiments;

FIG. 2 is a perspective view of the battery pack viewed from a rear side, according to embodiments;

FIG. 3 is an exploded perspective view of the battery pack shown in FIG. 1;

FIGS. 4A and 4B respectively are enlarged perspective views of portions IVa and IVb of FIG. 3;

FIG. 5 is an enlarged perspective view of a battery cell shown in FIG. 3;

FIG. 6 is a partially exploded perspective view of the battery pack shown in FIG. 3; and

FIG. 7 is a diagram showing an arrangement of upper and lower cooling plates of a battery pack according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” if preceding a list of elements, modify the entire list of elements and do not modify the individual elements of the list.

Hereinafter, a battery pack according to embodiments will be described with reference to the accompanying drawings.

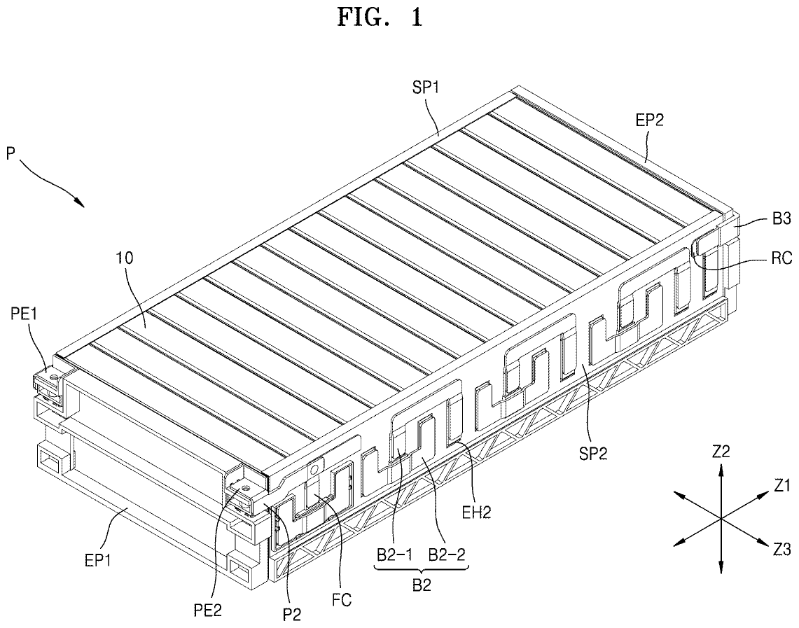

FIG. 1 is a perspective view of a battery pack P viewed from a front side according to embodiments.

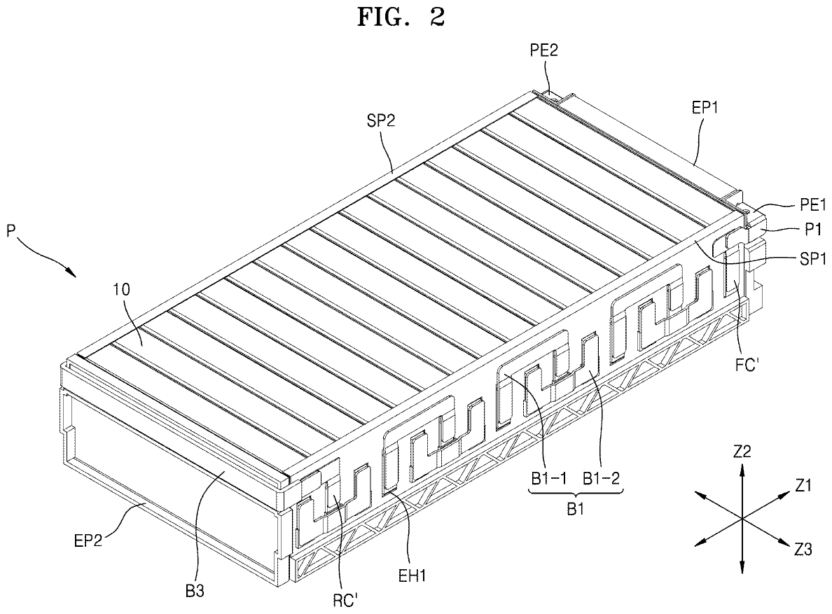

FIG. 2 is a perspective view of the battery pack P viewed from a rear side according to embodiments.

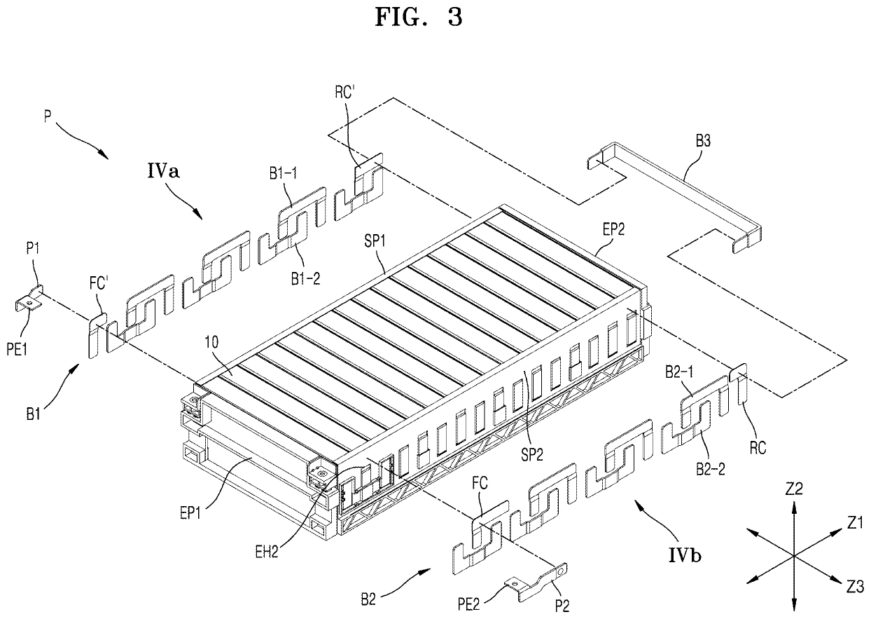

FIG. 3 is an exploded perspective view of the battery pack P shown in FIG. 1.

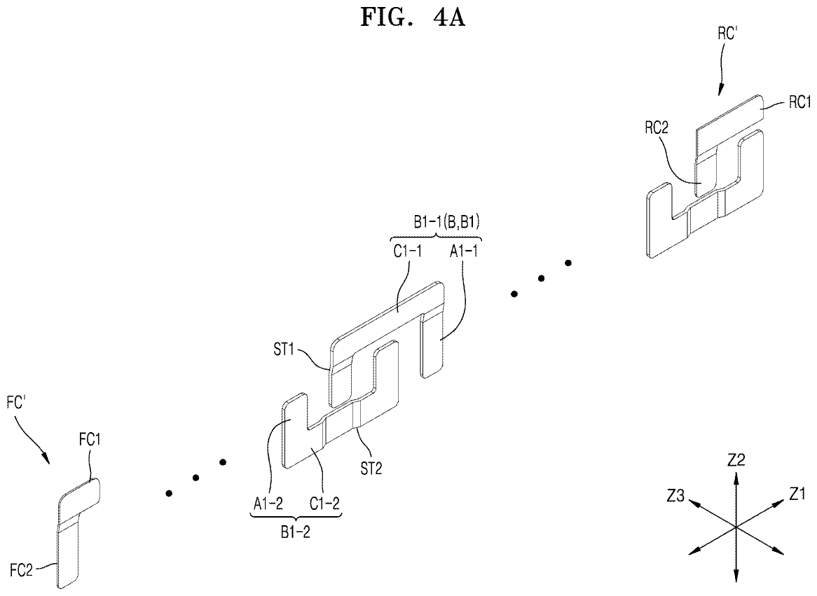

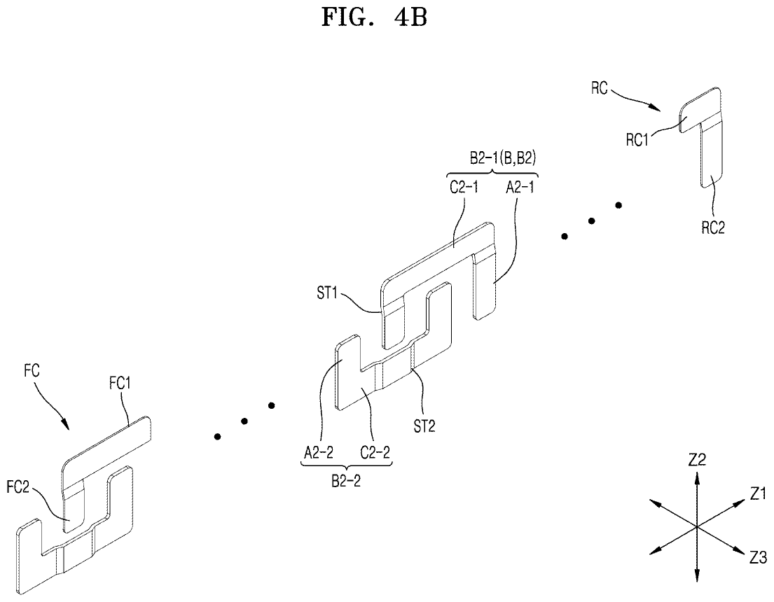

FIGS. 4A and 4B respectively are enlarged perspective views of portions IVa and IVb of FIG. 3.

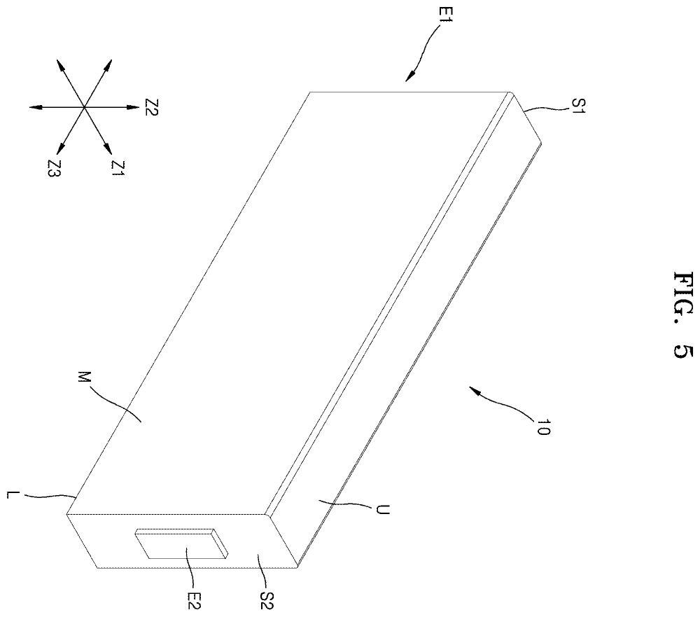

FIG. 5 is an enlarged perspective view of a battery cell shown in FIG. 3.

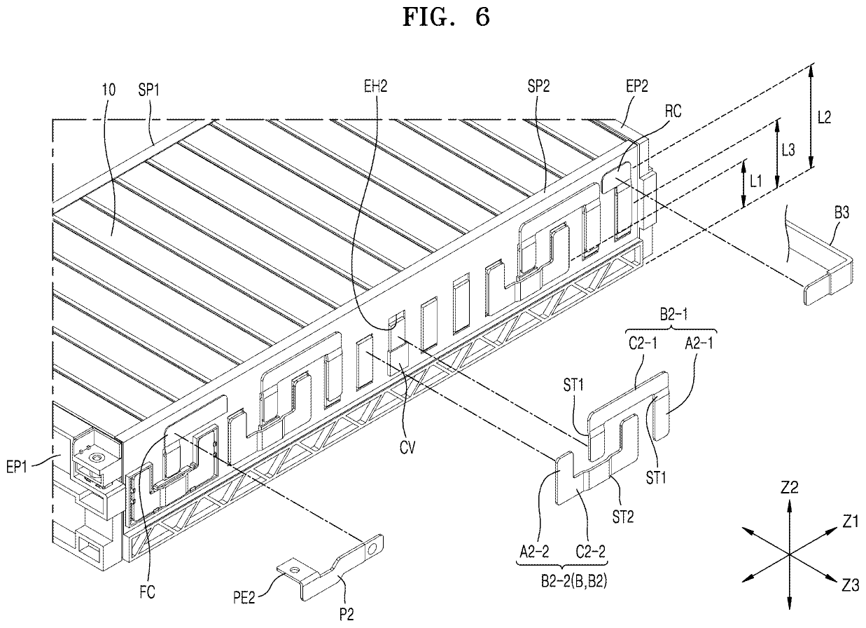

FIG. 6 is a partially exploded perspective view of the battery pack P shown in FIG. 3.

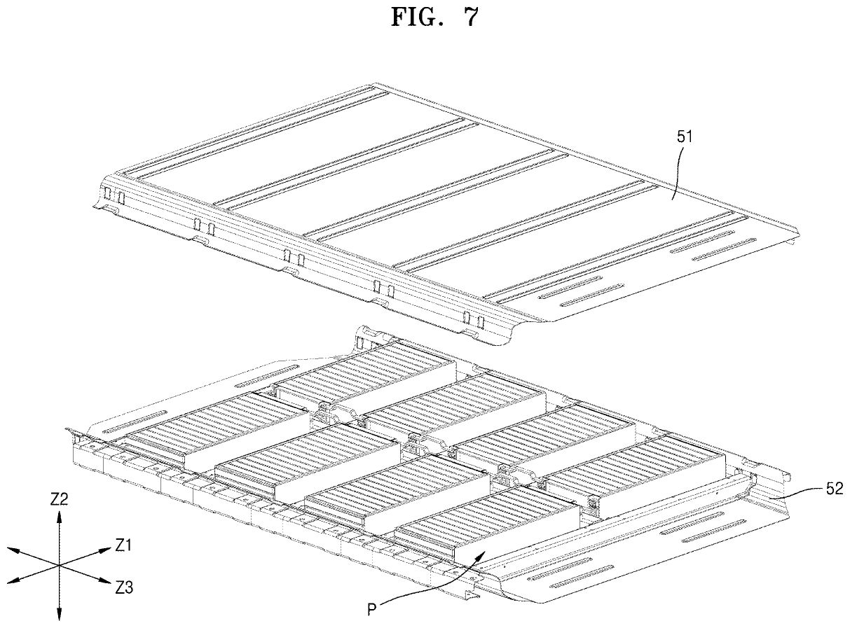

FIG. 7 is a diagram showing an arrangement of upper and lower cooling plates of the battery pack P according to embodiments.

Referring to the drawings, the battery pack P according to embodiments may include a plurality of battery cells 10 arranged back and forth in a first direction Z1, each including a pair of main surfaces M arranged to face each other in the first direction Z1, an upper surface U and a lower surface L connecting the pair of main surfaces M and forming a pair of long sides facing each other, and first and second side surfaces S1 and S2 forming a pair of short sides facing each other. First and second bus bars B1 and B2 electrically connect the plurality of battery cells 10 to each other in an alternating manner such that adjacent battery cells 10 in an arrangement direction of the battery cells 10 are not electrically connected to each other. A third bus bar B3 electrically connects first and second output terminals PE1 and PE2 formed together on a front side of the plurality of battery cells 10 in the first direction Z1 to the plurality of battery cells 10 adjacent to each other by detouring along a rear side of the plurality of battery cells 10.

In embodiments of the present disclosure, the plurality of battery cells 10 forming the battery pack P may be disposed so that the main surfaces M formed with relatively wide surfaces are arranged to face each other along the first direction Z1 in which the plurality of battery cells 10 are arranged. For example, in embodiments of the present disclosure, the battery cell 10 may include the first and second side surfaces S1 and S2 facing each other along a third direction Z3 that intersects the first and second directions Z1 and Z2, wherein the first and second side surfaces S1 and S2 form the long side of the battery cell 10 to connect the pair of main surfaces M facing each other along the first direction Z1 and form short sides of the battery cell 10 with the upper surface U and the lower surface L facing each other in the second direction Z2 corresponding to an up-down direction.

In embodiments of the present disclosure, the upper and lower surface U and L and the first and second side surfaces S1 and S2 connect the pair of main surfaces M facing each other in the first direction Z1 in which the plurality of battery cells 10 are arranged and may form a long side extending relatively long and a short side extending relatively short. More specifically, the upper surface U and the lower surface L of the battery cells 10 may form a pair of long sides arranged to face each other up-down in the second direction Z2 intersecting the first direction Z1 in which the plurality of battery cells 10 are arranged back and forth, and the first and second side surfaces S1 and S2 of the battery cell 10 may form a pair of short sides arranged to face each other in a third direction Z3 that intersects the first and second directions Z1 and Z2. In embodiments of the present disclosure, first and second electrode terminals E1 and E2 having different polarities may be formed on the first and second side surfaces S1 and S2 of the battery cell 10, respectively. Also, as described below, the first and second bus bars B1 and B2 disposed on the first and second sides S1 and S2 of the battery cell 10 may connect different first and second electrode terminals E1 and E2 of the battery cells 10 arranged alternately so as not to be adjacent to each other while forming a series connection. For example, in embodiments, the first and second bus bars B1 and B2 may form a series connection of different battery cells 10 arranged in an alternating manner such that adjacent battery cells are not electrically connected by the first and second bus bars B1 and B2 to each other.

In embodiments of the present disclosure, the battery pack P may include a series connection of the plurality of battery cells 10 forming the battery pack P and include a series connection between each unit battery cell 10 of the plurality of battery cells 10 forming the battery pack P. For example, the battery pack P in embodiments may not include a parallel connection between different battery cells 10. However, the battery pack P according to various embodiments may include a series connection of parallel modules arranged alternately so as not to be adjacent to each other in the first direction Z1 in which the plurality of parallel modules is arranged using a parallel module in which two or more adjacent battery cells 10 are connected in parallel as a unit. For example, in various embodiments, the parallel module may include a parallel connection of a single unit battery cell 10 to two or more battery cells 10, and in the embodiments shown in the drawings accompanied to this specification, it may be understood that each parallel module includes a unit battery cell 10 (a form of a parallel module including a unit battery cell 10). Also, while not shown in the drawings, the parallel module may include two or more battery cells 10 electrically coupled to each other through a parallel connection in which two or more battery cells 10 are connected in parallel.

The battery pack P according to embodiments may include a series connection of different battery cells 10 arranged alternately so as not to be adjacent to each other in the first direction Z1 corresponding to the arrangement direction of the plurality of battery cells 10. To this end, the first and second bus bars B1 and B2 may electrically connect terminals of different polarities of the battery cells 10 that are alternately arranged on the first and second side surface surfaces S1 and S2 of the battery cell 10 so as not to be adjacent to each other. Accordingly, in embodiments of the present disclosure, the first and second electrode terminals E1 and E2 of the battery cells 10 are arranged alternately so as not to be adjacent to each other in the first direction Z1, with the first and second electrode terminals E1 and E2 being exposed through the first and second side surfaces S1 and S2. Also, on the one hand, the first and second electrode terminals E1 and E2 of opposite polarity are connected in series through the first bus bar B1 or the second bus bar B2 disposed on the first side surface S1 or the second side surface S2, and the first and second electrode terminals E1 and E2 having the same polarity of the battery cells 10 adjacent to each other in the first direction may be exposed through same side surface as the first and second side surfaces S1 and S2. The first and second electrode terminals E1 and E2 may be arranged so that left and right positions thereof are reversed to each other in the first direction Z1 by using two battery cells 10 adjacent to each other as one unit. That is, the first and second side surfaces S1 and S2, on which the first and second electrode terminals E1 and E2 are formed, may be arranged in a reversed pattern.

The electrical path formed by the plurality of battery cells 10 forming the battery pack P may be arranged such that the first and second electrode terminals E1 and E2 of opposite polarities are exposed on the same side surface as the first side surface S1 or the second side surface S2 of the battery cells 10, with the terminals E1 and E2 being arranged alternately such that terminals of the same polarity are not adjacent to each other. Thus, the first and second bus bars B1 and B2 respectively disposed on the first and second side surfaces S1 and S2 of the battery cell 10 are alternately connected in series with a pair of battery cells 10 that are matched in an alternative manner such that the matched battery cells are not adjacent to each other in the first direction Z1. An electrical path connects a first group of battery cells 10, which are alternately arranged so as not to be adjacent to each other, in a zigzag pattern from the front position to the rear position, and an electrical path, a direction of which is reversed from the rear position to the front position through the third bus bar B3, connects a second group of battery cells 10 arranged alternately so as not to adjacent to each other in another zigzag pattern. The first and second electrode terminals E1 and E2 of the same polarity of the battery cells 10 adjacent to each other in the first direction may be exposed on same surface as the first side surface S1 or the second side surface S2 of the battery cells 10. The first and second electrode terminals E1 and E2 may be arranged so that left and right positions thereof are reversed to each other in the first direction Z1 by using two battery cells 10 adjacent to each other in the first direction Z1 as one unit, that is, the first and second side surfaces S1 and S2, on which different first and second electrode terminals E1 and E2 are formed, may be arranged in a reversed pattern. For example, in embodiments including a parallel module in which two or more battery cells 10 arranged adjacent to each other are connected in parallel, the battery cells 10 may be arranged so that the left and right arrangements of the battery cells 10 are reversed by using a pair of two adjacent parallel modules as one unit.

In embodiments of the present disclosure, upper and lower cooling plates 51 and 52 for cooling the battery cell 10 may be disposed on at least one long side among the upper surface U and the lower surface L of the battery cell 10 forming a relatively long side. For example, in embodiments of the present disclosure, an upper cooling plate 51 may be disposed on the upper surface U side of the battery cell 10, and a lower cooling plate 51 may be disposed on the lower surface L side of the battery cell 10. Referring to FIG. 7, the battery pack P, together with other battery packs P formed of substantially same structure, may constitute a power supply device for supplying driving power to a set device, such as an electric vehicle. At this time, the upper cooling plate 51 or the lower cooling plate 52 disposed on the upper surface U or the lower surface L of the battery pack P may extend across the upper surface U and the lower surface L of the plurality of battery packs P forming the power supply device to realize cooling together with respect to the plurality of the battery packs P, and also, the upper cooling plate 51 or the lower cooling plate 52 may form a housing of the power supply device, align an assembly position of the plurality of battery packs P, and structurally bind the plurality of battery packs P. In embodiments of the present disclosure, the first and second side surfaces S1 and S2 forming a height dimension of the battery pack P in the second direction Z2, which corresponds to the up-down direction, may form a short side extending a relatively short distance. Thus, the battery pack P has an advantageous slim size. To make a slim power supply device to be disposed at a bottom of a vehicle, such as an electric vehicle, a housing of the power supply device may be implemented from the upper cooling plate 51 and the lower cooling plate 52 disposed on the upper surface U and the lower surface of the battery pack P forming a power supply device, and thus, a slim power supply device may be provided.

In embodiments of the present disclosure, a bus bar B for electrical connection of the battery cell 10 may be disposed on at least one short side of the first and second side surfaces S1 and S2 of the battery cell 10 forming a relatively short side. For example, in embodiments of the present disclosure, the first and second bus bars B1 and B2 may be disposed on the first and second side surfaces S1 and S2 opposite to each other of the battery cell 10 forming a pair of opposite short sides of the battery cell 10.

In embodiments of the present disclosure, by disposing the upper cooling plate 51 and the lower cooling plate 52 for cooling the battery cell 10 and the bus bar B for electrical connection of the battery cells 10 on long side and the short side of the battery cell 10 that face each other in the second and third directions Z2 and Z3, the physical interference and electrical interference between the cooling of the battery cell 10 and the electrical connection may be eliminated. For example, a decrease in cooling performance due to a thermal resistance between the battery cell 10 and the upper cooling plate 51 and the lower cooling plate 52 may be prevented by eliminating the physical interference between the cooling of the battery cell 10 and the electrical connection of the battery cell 10, and also, an electrical short-circuit of the battery cell 10 may be prevented by eliminating the electrical interference between cooling of the battery cell 10 and the electrical connection of the battery cell 10.

In embodiments of the present disclosure, the first bus bar B1 may electrically connect different battery cells 10 that are alternately arranged so as not to be adjacent to each other on the first side surface S1 of the battery cell 10, and similarly, the second bus bar B2 may electrically connect different battery cells 10 that are alternately arranged so as not to be adjacent to each other on the second side surface S2 of the battery cell 10.

Also, as described below, by electrically connecting different battery cells 10 that are alternately arranged so as not to be adjacent to each other, rather than electrically connecting the first and second bus bars B1 and B2 to the battery cells 10 arranged adjacent to each other, the first and second output terminals PE1 and PE2 of the battery pack P may be concentrated on the front (first) side of the battery pack P. Also, by arranging the first and second output terminals PE1 and PE2 of the battery pack P adjacent to the front side of the battery pack P, the electrical connection between the battery pack P and set devices that use the battery pack P as a driving power source may be easily implemented. And because the first and second output terminals PE1 and PE2 are put out together to the front of the battery pack P, an electrical path for forming the first and second output terminals PE1 and PE2 may be reduced. As described below and throughout the specification, the first and second output terminals PE1 and PE2 are concentrated on the front side of the battery cell 10, the first and second output terminals PE1 and PE2 are formed adjacent to the front side of the battery cell 10, or the first and second output terminals PE1 and PE2 are drawn together towards the front side of the battery cell 10 may indicate that the first and second output terminals PE1 and PE2 of the battery pack P are drawn from the first and second battery cells 10 adjacent to each other forming the front side of the battery pack P. For example, in embodiments of the present disclosure, the first and second output terminals PE1 and PE2 of the battery pack P may be provided as one end of the first and second terminal connection members P1 and P2, and an end of the terminal connection members P1 and P2 may be directly connected to the first and second battery cells 10 disposed adjacent to each other at a front position of the battery pack P. For example, in embodiments of the present disclosure, the first and second output terminals PE1 and PE2 may be formed as a part of the first and second terminal connection members P1 and P2 extending from the first and second battery cells 10 disposed adjacent to each other at the front position from among the plurality of battery cells 10.

In embodiments of the present disclosure, as the first and second output terminals PE1 and PE2 are formed on the front side of the battery pack P, a third bus bar B3 for returning the electrical path may be disposed on the rear (second) side of the battery pack P. For example, in embodiments of the present disclosure, the electrical path formed by the plurality of battery cells 10 may form a U-turn path while passing from the first output terminal PE1 on the front side through the third bus bar B3 on the rear side, and again may form a path toward the second output terminal PE2 on the front side. For reference, throughout the specification, the front (first) or rear (second) of the battery pack P may denote the front or rear of the plurality of battery cells 10 forming the battery pack P. In embodiments of the present disclosure, the third bus bar B3 may electrically connect an n−1^{th} battery cell 10 and an n^{th} battery cell 10 to each other, which form the rear side of the battery cell 10 among the plurality of battery cells 10, and may electrically connect the neighboring n−1^{th} battery cells 10 and the n^{th} battery cell 10 to each other, which form the rear side of the battery cell 10 among the plurality of battery cells 10. For reference, in embodiments of the present disclosure, the battery pack P may include a total of n battery cells 10 including the first battery cell 10, the second battery cell 10, . . . the n−1^{th} battery cell 10, and the n^{th} battery cell 10 as sequentially arranged the plurality of battery cells 10 towards the rear position where the third bus bar B3 is disposed from the front position where the first and second output terminals PE1 and PE2 are formed, for example, where n is an integer greater than 1. Thus, the battery pack P according to embodiments may include two or more battery cells 10.

In embodiments of the present disclosure, the first and second output terminals PE1 and PE2 may draw from the first and second battery cells 10 adjacent to each other forming the front side among the plurality of battery cells 10, and the n^{th} and n−1^{th} battery cells 10 adjacent to each other forming the rear side of the battery pack P may be electrically connected to each other through the third bus bar B3. In embodiments of the present disclosure, by drawing out of the first and second output terminals PE1 and PE2 from the first and second battery cells 10 that are adjacent to each other on the front side among the plurality of battery cells 10, while the first and second output terminals PE1 and PE2 are concentrated on the front side of the battery pack P, the electrical connection of the plurality of battery cells 10 may be returned from the rear side to the front side through the third bus bar B3 that electrically connects the n^{th} and n−1^{th} battery cells 10 that are adjacent to each other on the rear side among the plurality of battery cells 10.

In embodiments of the present disclosure, the first and second bus bars B1 and B2 may electrically connect the battery cells 10 to each other in an alternating manner such that adjacent battery cells are not electrically connected to each other on the first and second side surfaces S1 and S2 of the battery cells 10, that is, the first and second bus bars B1 and B2 may electrically connect different battery cells 10 arranged in an alternating manner so that adjacent battery cells are not electrically connected to each other in the first direction Z1 in which the plurality of battery cells 10 are arranged. The third bus bar B3 may for a return electrical path of the plurality of battery cells 10 from the rear side to the front side while connecting the n^{th} and n−1^{th} battery cells 10 disposed at the rear position among the plurality of battery cells 10 to each other. For example, in embodiments of the present disclosure, the electrical path of the plurality of battery cells 10 may be formed from the front position towards the rear position, that is, towards the n−1^{th} battery cell 10 at the rear position from the first battery cell 10 at the front position connected to the first output terminal PE1. Further, the electrical path may be formed from the front position toward the rear position while alternately passing through the first and second bus bars B1 and B2 formed on the first and second side surfaces S1 and S2 of the battery cells 10, and may be connected to the n^{th} battery cell 10 from the n−1^{th} battery cell 10 through the third bus bar B3 formed at the rear position of the battery cells 10. The electrical path toward the rear position from the front position through the third bus bar B3 may be returned from the rear position towards the front position, for example, may be connected from the rear position to the front position from the n^{th} battery cell 10 in the rear position connected to the third bus bar B3 toward the second battery cell 10 in the front position, and may be connected towards the front position from the rear position while alternately passing the first and second bus bars B1 and B2 formed on the first and second side surfaces S1 and S2 of the battery cell 10. For example, the electrical path of the plurality of battery cells 10 may be formed between the first output terminal PE1 connected to the first battery cell 10 in the front position and the second output terminal PE2 connected to the second battery cell 10 in the front position, and may transmit discharge power of the battery cell 10 towards a set device (e.g., an external load) or may transmit charge power toward the battery cell 10 from a set device (e.g., an external charger) through a set device connected between the first and second output terminals PE1 and PE2 at the front position of the battery pack P.

In embodiments of the present disclosure, the electrical connection between the front and rear positions in the first direction Z1 in which the plurality of battery cells 10 are formed may be formed by alternately passing through the first and second bus bars B1 and B2 formed on the first and second side surfaces S1 and S2 of the battery cell 10, and the first and second output terminals PE1 and PE2 may be connected to the first and second battery cells 10 disposed at the front position among the plurality of battery cells 10 formed in the first direction Z1. The n−1^{th} and n^{th} battery cells 10 disposed at the rear position among the plurality of battery cells 10 formed in the first direction Z1 may be connected to each other through the third bus bar B3, and the direction of electrical connection of the battery cell 10 may be returned from the rear position to the front position.

In embodiments of the present disclosure, the first bus bar B1 may include a plurality of first bus bars B1 that electrically connect non-adjacent battery cells 10 to each other on the first side surface S1 of the battery cell 10. More specifically, the first bus bar B1 may include a 1st-1 bus bar B1-1 that connects non-adjacent battery cells 10 to each other while detouring along a relatively upper position of the battery cells 10 (for example, at a second level L2 from a bottom of a flat portion of side plates SP, SP1, and SP2) so as not to cause a short-circuit to each other. The first bus bar B1 may also include a 1 st-2 bus bar B1-2 that connects non-adjacent battery cells 10 to each other while detouring along a lower position of the battery cells 10 (for example, at a first level L1 from the bottom of the flat portion of the side plates SP, SP1, and SP2). For example, the 1st-1 bus bar B1-1 and the 1 st-2 bus bar B1-2 may avoid short-circuiting with respect to each other by electrically connecting different pairs of battery cells 10 that are not adjacent (matched) to each other while detouring along the upper and lower positions in the second direction Z2, respectively. For example, in embodiments of the present disclosure, the 1 st-1 bus bar B1-1 and the 1 st-2 bus bar B1-2 may be disposed in a comb shape in which the 1st-1 bus bar B1-1 and the 1st-2 bus bar B1-2 interlock into each other on the first side surfaces S1 of the battery cells 10. And, as described below, the 1 st-1 bus bar B1-1 and the 1st-2 bus bar B1-2 may electrically connect the pairs of battery cells 10, with the bus bars B1-1 and B1-2 being arranged to be misaligned with each other while avoiding short circuiting with respect to each other through a 1st-1 connection unit C1-1 and a 1 st-2 connection unit C1-2 disposed on the relatively upper and lower positions.

In embodiments of the present disclosure, the first bus bars B1 may include a pair of branch portions A1-1 and A1-2 coupled to the first and second electrode terminals E1 and E2 of the battery cells 10 arranged alternately so as not to be adjacent to each other, with the 1 st-1 connection unit C1-1 and the 1 st-2 connection unit C1-2 extending between the pair of branch portions A1-1 and A1-2 to connect the pair of branch portions A1-1 and A1-2 to each other. The 1st-1 bus bar B1-1 and the 1st-2 bus bar B1-2 may include the 1st-1 connection unit C1-1 and the 1st-2 connection unit C1-2 formed respectively at upper and lower positions to avoid short circuiting with respect to each other while connecting between pairs of different battery cells 10, with the 1 st-1 bus bar B1-1 and the 1st-2 bus bar B1-2 being arranged to be misaligned with each other. For example, the 1st-1 branch portion A1-1 and the 1st-2 branch portion A1-2 of the 1st-1 bus bar B1-1 and the 1 st-2 bus bar B1-2 may connect between the first and second electrode terminals E1 and E2 formed at substantially the same level in the second direction Z2, and the 1 st-1 connection unit C1-1 and the 1st-2 connection unit C1-2 respectively connecting the 1 st-1 branch portion A1-1 of the 1 st-1 bus bar B1-1 and the 1 st-2 branch portion A1-2 of the 1 st-2 bus bar B1-2 may be disposed at the upper and lower positions in the second direction Z2 to avoid a short-circuit therebetween.

More specifically, the 1 st-1 bus bar B1-1 may include the 1 st-1 connection unit C1-1 extending in the first direction Z1 in which the battery cells 10 are arranged at the upper position and a pair of 1st-1 branch portions A1-1 connected to the first and second electrode terminals E1 and E2 of the battery cells 10, with the 1 st-1 branch portions A1-1 extending from both ends of the 1 st-1 connection unit C1-1 toward the lower position in the second direction Z2 perpendicular to the first direction Z1. Similarly, the 1 st-2 bus bar B1-2 may include the 1 st-2 connection unit C1-2 extending in the first direction Z1 in which the battery cells 10 are arranged at the lower position and a pair of 1st-2 branch portions A1-2 connected to the first and second electrode terminals E1 and E2 of the battery cells 10 that extend from both ends of the 1 st-2 connection unit C1-2 toward the upper position in the second direction Z2 perpendicular to the first direction Z1.

In embodiments of the present disclosure, the second bus bar B2 may include a plurality of second bus bars B2 electrically connecting non-adjacent battery cells 10 to each other on the second side surfaces S2 of the battery cells 10. More specifically, the second bus bar B2 may include a 2nd-1 bus bar B2-1 that connects non-adjacent battery cells 10 to each other while detouring along the relatively upper position (for example, the second level L2 from the bottom of the flat portion of the side plates SP, SP1, and SP2) so as not to be short-circuited with respect to each other. The second bus bar B2 may also include a 2nd-2 bus bar B2-2 connecting non-adjacent battery cells 10 to each other while detouring along the lower position (e.g., the first level L1 from the bottom of the flat portion of the side plates SP, SP1, and SP2). The 2nd-1 bus bar B2-1 and the 2nd-2 bus bar B2-2 may avoid short-circuiting with respect to each other by electrically connecting different pairs of battery cells 10 that are not adjacent (matched) to each other while detouring along the upper and lower positions in the second direction Z2, respectively. For example, in embodiments of the present disclosure, the 2nd-1 bus bar B2-1 and the 2nd-2 bus bar B2-2 may be disposed in a comb shape in which the 2nd-1 bus bar B2-1 and the 2nd-2 bus bar B2-2 interlock into each other on the second side surfaces S1 of the battery cells 10. And, as described below, the 2nd-1 bus bar B2-1 and the 2nd-2 bus bar B2-2 may electrically connect the pairs of battery cells 10, with the bus bars B2-1 and B2-2 being misaligned with each other while avoiding short circuiting with each other through the 2nd-1 connection unit C2-1 and the 2-2 connection unit C2-2 disposed at relatively upper and lower positions.

In embodiments of the present disclosure, the second bus bars B2 may include a pair of branch portions A2-1 and A2-2 coupled to the first and second electrode terminals E1 and E2 of the battery cells 10 arranged alternately so as not to be adjacent to each other, with the 2nd-1 connection unit C2-1 and the 2-2 connection unit C2-2 extending between the pair of branch portions A2-1 and A2-2 to connect the pair of branch portions A2-1 and A2-2 to each other. The 2nd-1 bus bar B2-1 and the 2nd-2 bus bar B2-2 may include the 2nd-1 connection unit C2-1 and the 2nd-2 connection unit C2-2 formed respectively at upper and lower positions to avoid short circuiting with respect to each other while connecting between pairs of different battery cells 10, with the 2nd-1 bus bar B2-1 and the 2nd-2 bus bar B2-2 being arranged to be misaligned with each other. For example, the 2nd-1 branch portion A2-1 and the 2nd-2 branch portion A2-2 of the 2-1 bus bar B2-1 and the 2nd-2 bus bar B2-2 may connect between the first and second electrode terminals E1 and E2 formed at substantially the same level in the second direction Z2, and the 2nd-1 connection unit C2-1 and the 2nd-2 connection unit C2-2 respectively connecting the 2nd-1 branch portion A2-1 of the 2nd-1 bus bar B2-1 and the 2-2 branch portion A2-2 of the 2nd-2 bus bar B2-2 may be disposed at the upper and lower positions in the second direction Z2 to avoid a short-circuit therebetween.

More specifically, the 2nd-1 bus bar B2-1 may include the 2nd-1 connection unit C2-1 extending in the first direction Z1 in which the battery cells 10 are arranged at the upper position and a pair of 2nd-1 branch portions A2-1 connected to the first and second electrode terminals E1 and E2 of battery cells 10, with the 2nd-2 branch portions A2-1 extending from both ends of the 2nd-1 connection unit C2-1 toward the lower position in the second direction Z2 perpendicular to the first direction Z1. Similarly, the 2nd-2 bus bar B2-2 may include the 2nd-2 connection unit C2-2 extending in the first direction Z1 in which the battery cells 10 are arranged at the lower position and a pair of 2nd-2 branch portions A2-2 connected to the first and second electrode terminals E1 and E2 of the battery cells 10 that extend from both ends of the 2nd-2 connection unit C2-2 toward the upper position in the second direction Z2 perpendicular to the first direction Z1.

The third bus bar B3 may include a main body disposed on a rear side of the battery pack P and a pair of connection units bent from the main body toward the first and second side surfaces S1 and S2 of the battery cells 10. For example, the third bus bar B3 may be formed to surround a rear-end plate EP2 forming the rear side of the battery pack P and may extend to surround the rear-end plate EP2 by including the main body disposed on the rear side of the battery pack P and the pair of connection units bent from the main body toward the first and second side surfaces S1 and S2 of the battery cells 10. Further, the third bus bar B3 may be disposed to surround the rear-end plate EP2 forming the rear side of the battery pack P at the upper position (e.g., the second level L2 from the bottom of the flat portions of the side plates SP, SP1, SP2). The third bus bar B3 may be electrically connected to the n−1^{th} battery cell 10 and the n^{th} battery cell 10 by disposing a rear connection bar RC between the n−1^{th} battery cell 10 and the n^{th} battery cell 10. The rear connection bar RC may include a first portion RC1 disposed at the same upper position as the third bus bar B3 (e.g., the second level L2 from the bottom of the flat portions of the side plates SP, SP1, and SP2) and a second portion RC2 forming a connection with the first and second electrode terminals E1 and E2 of the n−1^{th} battery cell 10 and the n^{th} battery cell 10 by extending from the first portion RC1. For example, the rear connection bar RC may include the first portion RC1 extending in the first direction Z1 and the second portion RC2 extending in the second direction Z2 to form a connection margin with the third bus bar B3 extending in the first direction Z1 and include the second portion RC2 extending in the second direction Z2 to form an electrical connection with the first and second electrode terminals E1 and E2 of the n−1^{th} battery cell 10 and the n^{th} battery cell 10.

In embodiments of the present disclosure, the first and second terminal connection members P1 and P2 may include the first and second output terminals PE1 and PE2 disposed on a front-end plate EP1 forming the front of the battery pack P. And, in embodiments of the present disclosure, the first and second terminal connection members P1 and P2 may include an end that extends from one end of the first and second battery cells 10 side in the first direction Z1, is bent toward the front-end plate EP1 forming the front of the battery pack P and the first and second output terminals PE1 and PE2 on the front-end plate EP1. In embodiments of the present disclosure, the first and second terminal connection members P1 and P2 may be electrically connected to the first and second battery cells 10 via a front connection bar FC. The front connecting bar FC may include a first portion FC1 extending in the first direction Z1 at the upper position (e.g., the second level L2 from the bottom of the flat portions of the side plates SP, SP1, and SP2) and a second portion FC2 extending from the first portion FC1 in the second direction Z2 and connected to the first and second electrode terminals E1 and E2 of the first and second battery cells 10. The front connection bar FC may include the first portion FC1 extending in the first direction Z1 in which the first and second terminal connection members P1 and P2 extend to form a connection margin with the first and second terminal connection members P1 and P2 extending in the first direction Z1 and may include the second portion FC2 extending in the second direction Z2 to form an electrical connection to the first and second electrode terminals E1 and E2 of the first and second battery cells 10.

In embodiments of the present disclosure, the plurality of battery cells 10 forming the battery pack P may be electrically connected to each other through the first to third bus bars B1, B2, and B3. For example, the plurality of battery cells 10 may include serial connections of battery cells 10 arranged in an alternating manner, and the plurality of battery cells 10 may be physically coupled through, as plates surrounding the plurality of battery cells 10 forming the battery pack P, the front-end plate EP1 and the rear-end plate EP2, which are disposed to face each other with the plurality of battery cells 10 therebetween in the first direction Z1, and a pair of side plates SP, SP1, and SP2 arranged to face each other by disposing the plurality of battery cells 10 therebetween in the third direction Z3. More specifically, in embodiments of the present disclosure, the front-end plate EP1 and the rear-end plate EP2 may be arranged at both (first and second) sides of the battery cell 10 in the first direction Z1 corresponding to the arrangement direction of the plurality of battery cells 10, and a pair of side plates SP, SP1, and SP2 may be disposed on both sides of the battery cell 10 in the third direction Z3 that intersects the first direction Z1. The pair of side plates SP, SP1, and SP2 may cover the first and second side surfaces S1 and S2 of the plurality of battery cells 10 while extending across the first and second side surfaces S1 and S2 of the plurality of battery cells 10 in the first direction Z1, and first and second terminal holes EH1 and EH2 may be formed in the pair of side plates SP, SP1, and SP2 to expose the first and second electrode terminals E1 and E2 formed on the first and second side surfaces S1 and S2. The first and second electrode terminals E1 and E2 formed on the first and second side surfaces S1 and S2 of the battery cells 10 may be exposed to outside of the side plates SP, SP1, and SP2 through the terminal holes EH1 and EH2 of the side plates SP, SP1, and SP2 and may be connected to the first and second bus bars B1 and B2 arranged on the side plates SP, SP1, and SP2, the front connecting bar FC, and the rear connecting bar RC. For example, in embodiments of the present disclosure, the first and second terminal holes EH1 and EH2 formed in the side plates SP, SP1, and SP2 may be formed on substantially the same third level L3 (for example, the third level L3 from the bottom of the flat portions of the side plates SP, SP1, and SP2) in the second direction Z2.

In embodiments of the present disclosure, the first and second bus bars B1 and B2, the front connecting bar FC, and the rear connecting bar RC may be disposed on the side plates SP, SP1, and SP2, and may form an electrical connection with the first and second electrode terminals E1 and E2 that are disposed on an outer surface of the side plates SP, SP1, and SP2 and exposed to outside of the side plates SP, SP1, and SP2 through the first and second terminal holes EH1 and EH2 formed in the side plates SP, SP1, and SP2. In embodiments of the present disclosure, the first and second electrode terminals E1 and E2 may be formed to protrude in the third direction on the first and second side surfaces S1 and S2 of the battery cells 10 and form an electrical connection with the front connection bar FC and the rear connection bar RC disposed on the side plates SP, SP1, and SP2 and the first and second bus bars B1 and B2 through the first and second terminal holes EH1 and EH2 formed in the side plates SP, SP1, and SP2 covering the first and second side surfaces S1 and S2 of the battery cells 10. For example, in embodiments of the present disclosure, on the first and second side surfaces S1 and S2 of the battery cells 10, the first and second electrode terminals E1 and E2 may be formed to protrude from a central position of the first and second side surfaces S1 and S2, and the first and second electrode terminals E1 and E2 may be formed with a step difference in the third direction Z3 from edges of the first and second side surfaces S1 and S2.

In embodiments of the present disclosure, the first and second battery cells 10 formed at the front (first) position among the plurality of battery cells 10 may be connected to the first and second terminal connection members P1 and P2 via the front connection bar FC, and among the plurality of battery cells 10, the n−1^{th} battery cell 10 and the n^{th} battery cell 10 forming the rear position may be connected to the third bus bar B3 via the rear connection bar RC. At this time, the front connection bar FC and the rear connection bar RC may be directly connected to the first and second electrode terminals E1 and E2 of the battery cell 10, may be disposed at positions (positions directly connected to the first and second electrode terminals E1 and E2 exposed through the first and second terminal holes EH1 and EH2 formed in the side plates SP, SP1, and SP2) directly connected to the first and second electrode terminals E1 and E2 of the battery cell 10. The front connection bar FC and the rear connection bar RC may be coupled, for example, by welding, etc. to the first and second electrode terminals E1 and E2 of each battery cell 10 to form connection points with the first and second electrode terminals E1 and E2 of each battery cell 10. In addition, the first and second terminal connection members P1 and P2 and the third bus bar B3 may be connected to the front connection bar FC and the rear connection bar RC, respectively. For example, in embodiments of the present disclosure, the front connection bar FC, the rear connection bar RC, and the first and second bus bars B1 and B2 may be coupled by welding, etc. to the first and second electrode terminals E1 and E2 exposed from the first and second terminal holes EH1 and EH2 of the side plates SP, SP1, and SP2 covering the first and second side surfaces S1 and S2 of the battery cells 10, and the third bus bar B3 and the first and second terminal connection members P1 and P2 may be connected by adding on the front connection bar FC and the rear connection bar RC that are coupled by welding, etc. to the first and second electrode terminals E1 and E2 of the battery cells 10.

In embodiments of the present disclosure, while uniformly applying a connection process, such as welding, etc. for connecting the first and second electrode terminals E1 and E2 and the first and second bus bars B1 and B2 to the front connection bar FC and the rear connection bar RC, a connection process of connecting the first and second the electrode terminals E1 and E2 of each battery cell 10 to the front connection bar FC and the rear connection bar RC may be performed as single process and after the connection process with the first and second electrode terminals E1 and E2 of the battery cell 10, a connection process for connecting the first and second terminal connection members P1 and P2 to the third bus bar B3 may be performed. In this way, according to embodiments of the present disclosure, as the connection process of the first and second electrode terminals E1 and E2 of the battery cells 10 to the front connection bar FC and the rear connection bar RC is uniformly performed, the yield of the product may be improved, and a battery pack P that is advantageous for an automation process may be provided.

In embodiments of the present disclosure, among the first and second bus bars B1 and B2, the 1-1 bus bar B1-1 formed at a relatively upper position (for example, the second level L2 from the bottom of the flat portion of the side plates SP, SP1, and SP2) and the 1-1 connection unit C1-1 and the 2-1 connection unit C2-1 of the 2-1 bus bar B2-1 may be formed at the relatively upper position in the second direction Z2, and, among the front connection bar FC and the rear connection bar RC, first portions FC1 and RC1 disposed at the relatively upper position (for example, the second level L2 from the bottom of the flat portion of the side plates SP, SP1, and SP2) may be disposed at the same level as the 1st-1 bus bar B1-1 and the 1st-1 connection unit C1-1 and the 2nd-1 connection unit C2-1 of the 2nd-1 bus bar B2-1, that is, at an upper position of the same level in the second direction Z2, and thus a battery pack P that is advantageous for positional alignment or automation process may be provided. For example, in embodiments of the present disclosure, by disposing the 1st-1 connection unit C1-1 of the 1^{st}-1 bus bar B1-1 and the 2nd-1 connection unit C2-1 of the 2nd-1 bus bar B2-1 that are formed on the first and second side surfaces S1 and S2 of the battery cells 10 at the same upper position (for example, the second level L2 from the bottom of the flat portion of the side plates SP, SP1, and SP2) and also by disposing the first portions FC1 and RC1 of the front connection bar FC and the rear connection bar RC at the same upper position (for example, the second level L2 from the bottom of the flat portion of the side plates SP, SP1, and SP2), the positional alignment of the plurality of electrical connections forming the battery pack P may be easily achieved and short circuits due to positional misalignment may be avoided.

In embodiments of the present disclosure, among the first and second bus bars B1 and B2, the 1 st-2 connection unit C1-2 of the 1 st-2 bus bar B1-2 formed at a lower position (for example, the first level L1 from the bottom of the flat portion of the side plates SP, SP1, and SP1) and the 2nd-2 connection unit C2-2 of the 2nd-2 bus bar B2-2 may be formed at a relatively lower position in the third direction Z3, and by disposing the 1st-2 connection unit C1-2 of the 1st-2 bus bar B1-2 and the 2nd-2 connection unit C2-2 of the 1 st-2 bus bar B1-2 at the same lower level (for example, the first level L1 from the bottom of the flat portion of the side plates SP, SP1, and SP1), for example, by disposing the 1st-2 connection unit C1-2 of the 1-2 bus bar B1-2 and the 2nd-2 connection unit C2-2 of the 2nd-2 bus bar B2-2 that are disposed on the first and second side surfaces S1 and S2 of the battery cell 10 at the same lower level, the positional alignment between the electrical connections forming the battery pack P may be easily achieved and short circuiting due to positional misalignment is avoided. In embodiments of the present disclosure, the first and second terminal connection members P1 and P2 extending in the first direction Z1 to form connections with the first portions FC1 and RC1 along the first portions FC1 and RC1 of the front connection bar FC and the rear connection bar RC disposed at the upper position (for example, the second level L2 from the bottom of the flat portion of the side plates SP, SP1, and SP2) equal to the level of the 1st-1 connection unit C1-1 of the 1st-1 bus bar B1-1 and the 2nd-1 connection unit C2-1 of the 2nd-1 bus bar B2-1 and the third bus bar B3 may also be positioned at the same level (for example, the second level L2 from the bottom of the flat portion of the side plates SP, SP1, and SP2) as the upper position.

In embodiments of the present disclosure, a cover piece CV may be formed to close a portion of the first and second terminal holes EH1 and EH2 (for example a lower portion of the first and second terminal holes EH1 and EH2) in the first and second terminal holes EH1 and EH2 formed in the side plates SP, SP1, and SP2. For example, the plurality of first bus bars B1 disposed on the first side surfaces S1 of the battery cells 10 may electrically connect pairs of battery cells 10 that are matched to be staggered with each other and may extend across the battery cell 10 disposed between the connected t pair of battery cells 10 to avoid an electrical connection with the interposed battery cell 10, and an erroneous connection with the battery cell 10 interposed between the connected battery cells may be blocked by cover piece CV covering a portion of the first and second terminal holes EH1 and EH2 that expose the first and second electrode terminals E1 and E2 of the battery cell 10 interposed between the connected battery cells, for example, covering a lower portion of the first and second terminal holes EH1 and EH2.

For example, in embodiments of the present disclosure, the first and second terminal holes EH1 and EH2 formed in the side plates SP, SP1, and SP2 may be formed in a position biased toward the lower position rather than the upper position on which many electrical connections are arranged, such as the 1st-1 connection unit C1-1 of the 1 st-1 bus bar B1-1 and the 2-1 connection unit C2-1 of the 2nd-1 bus bar B2-1 disposed at the same upper position level (the second level L2 from the bottom of the flat portion of the side plates SP, SP1, and SP2), and the first portions FC1 and RC1 of the front connection bar FC and the rear connection bar RC, for example, the first and second terminal holes EH1 and EH2 of the side plates SP, SP1, and SP2 may be formed at a position biased toward the lower position where relatively few electrical connections are formed, such as the 1 st-2 connection unit C1-2 of the 1 st-2 bus bar B1-2 and the 2nd-2 connection unit C2-2 of the 2nd-2 bus bar B2-2, and accordingly, the cover piece CV may be formed at the lower portion of the first and second terminal holes EH1 and EH2 where the 1st-2 connection unit C1-2 of the 1st-2 bus bar B1-2 and the 2nd-2 connection unit C2-2 of the 2nd-2 bus bar B2-2 extend across to avoid erroneous connection therebetween.

In embodiments of the present disclosure, with respect to the arrangement of the first and second bus bars B1 and B2, the front connecting bar FC, and the rear connecting bar RC, the upper position and the lower position in the second direction Z2 refer to the first and second levels L1 and L2 from the bottom of the relatively flat portion for arranging components involved in the electrical connection of the battery cells 10 among the side plates SP, SP1, and SP2. And, as described above, the description that the first and second terminal holes EH1 and EH2 formed in the side plates SP, SP1, and SP2 being formed at the positions biased toward the lower position rather than the upper position may refer, rather than referring to the upper and lower positions among all side plates SP, SP1, and SP2, among all side plates SP, SP1, and SP2, to the upper and lower positions among the flat portions of the side plates SP, SP1, and SP2 where components involved in the electrical connection of the battery cell 10 are placed.

In embodiments of the present disclosure, the first bus bar B1 disposed on the first side surface S1 of the battery cell 10 may include the 1st-1 bus bar B1-1 including the 1 st-1 connection unit C1-1 at the upper position and the 1 st-2 bus bar B1-2 including the 1 st-2 connection unit C1-2 at the lower position, and the 1 st-1 connection unit C1-1 may extend to detour along the top of the first terminal hole EH1 and may be formed flat on the side plates SP, SP1, and SP2. In contrast, the 1st-2 connection unit C1-2 may include a step difference unit ST2 stepped in a direction away from the side plates SP, SP1, and SP2 to accommodate a protrusion of the cover piece CV for closing a portion of the first terminal hole EH1,

In embodiments of the present disclosure, the 1st-1 bus bar B1-1 and the 1st-2 bus bar B1-2 may be formed on different support bases, for example, the 1 st-1 bus bar B1-1 may include a pair of step difference units ST1 stepped toward the first and second electrode terminals E1 and E2 from the 1st-1 connection unit C1-1 by using the 1st-1 connection unit C1-1 on the side plates SP, SP1, and SP2 as a support base, and the 1st-2 bus bar B1-2 may include the step difference unit ST2 formed on the 1st-2 connection unit C1-2 connecting the 1st-2 branch portion A1-2 by using the 1st-2 branch portion A1-2 disposed on the first and second electrode terminals E1 and E2 exposed through the first and second terminal holes EH1 and EH2 of the side plates SP, SP1, and SP2.

Similarly, in embodiments of the present disclosure, the second bus bar B2 disposed on the second side surfaces S2 of the battery cells 10 may include the 2nd-1 bus bar B2-1 including the 2nd-1 connection unit C2-1 and the 2nd-2 bus bar B2-2 including the 2nd-2 connection unit C2-2, and the 2nd-1 connection unit C2-1 may extend to detour along the top of the first and second terminal holes EH1 and EH2 and may be formed flat on the side plates SP, SP1, and SP2. In contrast, the 2-2 connection unit C2-2 may include the step difference unit ST2 stepped in a direction away from the side plates SP, SP1, and SP2 to accommodate a protrusion of the cover piece CV for closing a portion of the second terminal hole EH2. The 2nd-1 bus bar B2-1 and the 2nd-2 bus bar B2-2 may be formed on different support bases, for example, the 2nd-1 bus bar B2-1 may include a pair of step difference units ST1 stepped toward the first and second electrode terminals E1 and E2 from the 2nd-1 connection unit C2-1 by using the 2nd-1 connection unit C2-1 on the side plates SP, SP1, and SP2 as a support base, and the 2-2 bus bar B2-2 may include the step difference unit ST2 formed on the 2-2 connection unit C2-2 connecting the 1 st-2 branch portion A1-2 by using the 1st-2 branch portion A1-2 disposed on the first and second electrode terminals E1 and E2 exposed through the first and second terminal holes EH1 and EH2 of the side plates SP, SP1, and SP2.

In other words, in embodiments of the present disclosure, the 1 st-1 bus bar B1-1 or the 2nd-1 bus bar B2-1 may include the 1st-1 connection unit C1-1 or the 2nd-1 connection unit C2-1 disposed on the side plates SP, SP1, and SP2 and a pair of the 1st-1 branch portion A1-1 or a pair of the 2-1 branch portion A2-1 that is extended from the 1 st-1 connection unit C1-1 or the 2nd-1 connection unit C2-1, is connected to the first and second electrode terminals E1 and E2 exposed to outside of the side plates SP, SP1, and SP2 through the first and second terminal holes EH1 and EH2 of the side plates SP, SP1, and SP2, and is formed stepwise towards outside through a bending unit from the 1 st-1 connection unit C1-1 or the 2nd-1 connection unit C2-1.

The 1st-2 bus bar B1-2 or the 2nd-2 bus bar B2-2 may include a pair of 1st-2 branch portions A1-2 or a pair of 2nd-2 branch portions A2-2 connected to the first and second electrode terminals E1 and E2 exposed to outside of the side plates SP, SP1, and SP2 through the first and second terminal holes EH1 and EH2 of the side plates SP, SP1, and SP2 and the 1st-2 connection unit C1-2 or a 2nd-2 connection portion C2-2 connecting the pair of the 1st-2 branch portions A1-2 or the pair of the 2nd-2 branch portions A2-2 to each other and formed to be stepped outward from the pair of 1 st-2 branch portions A1-2 or the pair of 2nd-2 branch portions A2-2 through the step difference unit ST2 to accommodate the cover piece CV.

In embodiments of the present disclosure, the plurality of battery cells 10 may be arranged so that the main surfaces M face each other in the first direction Z1 corresponding to the arrangement direction of the battery cells 10. Further, the upper surfaces U and lower surfaces L connecting the main surfaces M and the first and second side surfaces S1 and S2 may form the long sides and the short sides extending lengthwise of the battery cells 10. In embodiments of the present disclosure, the upper cooling plate 51 and the lower cooling plate 52 may be provided on the upper surfaces U and the lower surfaces L forming the long sides lengthwise.

In embodiments of the present disclosure, by arranging the upper cooling plate 51 and the lower cooling plate 52 on the upper surfaces U and lower surfaces L of the battery cells 10, a relatively large cooling area may be secured through the upper cooling plate 51 and lower cooling plate 52 disposed on the upper surfaces U and lower surfaces L while avoiding physical and electrical interferences with the electrical connections formed through the first and second side surfaces S1 and S2, which are arranged to face each other in the third direction Z3 crossing the first direction Z1. For example, in embodiments of the present disclosure, by arranging a battery pack P including a plurality of battery cells 10, or a plurality of battery packs P using the first and second sides S1 and S2 of the battery cells 10, which form short sides, as a height dimension, or a power supply device including the battery pack P, may be provided. For example, the battery pack P with a reduced height may be provided as a power supply device of an electric vehicle, wherein the small height is advantageously slim, and, thus, does not to affect the height of the electric vehicle due to the height of the battery pack P located at a lower side of the vehicle.

In embodiments of the present disclosure, by considering the arrangement of the plurality of battery cells 10 arranged with the main surfaces M facing each other in the first direction Z1 in which the plurality of battery cells 10 are arranged and by arranging the plurality of battery cells 10 using the first and second side surfaces S1 and S2 as height dimensions that are disposed to face each other in the second direction Z2, the battery pack P that is advantageously slim may be provided. Also, by connecting the pairs of the main surfaces M facing each other in the first direction Z1 and form the short side, and by forming electrical connection of the battery cells 10 through the first and second side surfaces S1 and S2, the arrangement of electrical components may be removed or minimized from the upper surface U and lower surface L of the battery cell 10, and thus, the battery pack P that is advantageously slim may be provided, and at the same time, the battery pack P that may have increased cooling area by arranging the upper cooling plate 51 and the lower cooling plate 52 on the upper surfaces U and the lower surfaces L forming the relatively long side, respectively.

According to embodiments of the present disclosure, output terminals of different polarities are formed adjacent to each other to facilitate electrical connection with set devices. The electrical path of the output terminal is shortened to improve electrical output, while improving space utilization through a simplified structure and providing robustness against external vibration and shock. The bus bars for electrical connection between the cooling plates for cooling the battery cells and the battery cells arranged on the long side and short side of the battery cells facing each other in a direction crossing each other, and thus, physical and electrical interference between the cooling of the battery cells and the electrical connection of the battery cells may be eliminated. The cooling area may be increased by arranging the cooling plates on the upper and lower surfaces that form a relatively long side extending lengthwise, and by forming electrical connections on the first and second side surfaces forming the short side, it is possible to provide a battery pack that is advantageously slim without affecting the short sides forming the height dimension.

The present disclosure has been described with reference to the embodiments shown in the accompanying drawings, but it will be understood by those of ordinary skill in the art that various changes in form and details may be made therein without departing from the spirit and scope of the inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims.

What is claimed is:

1. A battery pack comprising:
a plurality of battery cells arranged in a first direction, each battery cell including (i) a pair of main surfaces arranged to face each other in the first direction, (ii) upper and lower surfaces forming a pair of long sides facing each other, and (iii) first and second side surfaces forming a pair of short sides facing each other, with the upper and lower surfaces and the first and second side surfaces connecting the main surfaces to each other;
first and second bus bars electrically connecting battery cells of the plurality of battery cells to each other in an alternating manner such that adjacent battery cells in the first direction are not electrically connected to each other by the first and second bus bars; and
first and second output terminals formed together on a first side of the plurality of battery cells in the first direction and a third bus bar that electrically connects adjacent battery cells to each other at a second side of the plurality of the battery cells that is opposite to the first side.

2. The battery pack as claimed in claim 1, wherein the first and second output terminals draw from first and second battery cells of the plurality of battery cells, the first and second battery cells being arranged adjacent to each other at the first side of the plurality of battery cells, and
the third bus bar connects an n−1^{th} battery cell and an n^{th} battery cell positioned adjacent to each other at the second side of the plurality of battery cells, with n being an integer greater than 1.

3. The battery pack as claimed in claim 1, further comprising an upper cooling plate and a lower cooling plate positioned on the upper and lower surfaces, respectively, forming the long sides of the plurality of battery cells.

4. The battery pack as claimed in claim 1, wherein the upper and lower surfaces of each battery cell face each other in a second direction that intersects the first direction, and
wherein the first and second side surfaces of the battery cell face each other in a third direction that intersects the first and second directions.

5. The battery pack as claimed in claim 1, wherein the first bus bar comprises a plurality of first bus bars and the second bus bar comprises a plurality of second bus bars, the plurality of first bus bars electrically connecting non-adjacent battery cells to each other on first side surfaces of the plurality of battery cells, and the plurality of second bus bars electrically connecting non-adjacent battery cells to each of on second side surfaces of the plurality of battery cells,
wherein the plurality of first bus bars includes a 1st-1 bus bar and a 2nd-1 bus bar that connects non-adjacent battery cells to each other while bypassing an upper position adjacent to the upper surfaces of the battery cells so as not to cause a short-circuit to each other, and
wherein the plurality of second bus bars includes a 1 st-2 bus bar and a 2nd-2 bus bar that connects non-adjacent battery cells to each other while bypassing a lower position adjacent to the lower surfaces of the battery cells so as not to cause a short-circuit to each other.

6. The battery pack as claimed in claim 5, wherein the 1 st-1 bus bar and the 1 st-2 bus bar are arranged to interlock with each other on the first side surfaces of the plurality of battery cells and connect the battery cells that are not adjacent to each other without short circuiting by detouring the upper positions and the lower positions, respectively, and
wherein the 2nd-1 bus bar and the 2nd-2 bus bar are arranged to interlock with each other on the second side surfaces of the plurality of battery cells and connect the battery cells that are not adjacent to each other without short circuiting by detouring the upper positions and the lower positions, respectively.

7. The battery pack as claimed in claim 5, wherein the 1st-1 bus bar comprises a 1 st-1 connection unit extending in the first direction at the upper positions of the battery cells and a pair of 1st-1 branch portions extending from both ends of the 1st-1 connection unit toward the lower positions of the battery cells and connected to electrode terminals of the battery cells that are not adjacent to each other, and
wherein the 1st-2 bus bar comprises a 1st-2 connection unit extending in the first direction at the lower positions of the battery cells and a pair of 1st-2 branch portions extending from both ends of the 1 st-2 connection unit toward the upper positions of the battery cells and connected to electrode terminals of the battery cells that are not adjacent to each other.

8. The battery pack as claimed in claim 5, wherein the 2nd-1 bus bar comprises a 2nd-1 connection portion extending along a first direction at an upper positions of the battery cells and a pair of 2nd-1 branch portions extending from both ends of the 2nd-1 connection portion toward lower positions of the battery cells and connected to electrode terminals of the battery cells that are not adjacent to each other, and
wherein the 2nd-2 bus bar comprises a 2nd-2 connection unit extending in the first direction at the lower positions of the battery cells and a pair of 2nd-2 branch portions extending from both ends of the 2nd-2 connection unit toward the upper positions of the battery cells and connected to electrode terminals of the battery cells that are not adjacent to each other.

9. The battery pack as claimed in claim 1, wherein the third bus bar extends to surround a rear end plate disposed at a rear position at the second side of the plurality of battery cells, and the third bus bar is bent so as to extend along the first and second side surfaces of the n−1^{th} battery cell and the n^{th} battery cell that are adjacent to each other at the rear position.

10. The battery pack as claimed in claim 9, wherein the third bus bar connects the n−1^{th} battery cell and the n^{th} battery cell that are adjacent to each other at the rear position via a rear connection bar.

11. The battery pack as claimed in claim 10, wherein the rear connection bar comprises:
a first portion extending in the first direction in which the third bus bar extends at upper positions on the first and second side surfaces of the n−1^{th} battery cell and the n^{th} battery cell; and
a second portion extending from the first portion toward lower positions on the first and second side surfaces of the n−1^{th} battery cell and the n^{th} battery cell and connected to electrode terminals of the n−1^{th} battery cell and the n^{th} battery cell.

12. The battery pack as claimed in claim 1, further comprising first and second terminal connection members each including ends forming the first and second output terminals at a front-end plate disposed at a front position at the first side of the plurality of battery cells, the first and second terminal connection members extending in the first direction from ends connected to an electrode terminal of a first battery cell and an electrode terminal of a second battery cell, respectively, that are arranged adjacent to each other at the front position among the plurality of battery cells.

13. The battery pack as claimed in claim 12, wherein the first and second terminal connection members are connected by a front connection bar to the first and second battery cells arranged adjacent to each other in the front position.

14. The battery pack as claimed in claim 13, wherein the front connecting bar comprises:
a first portion extending in the first direction in which the first and second terminal connection members extend at upper positions on first and second side surfaces of the first and second battery cells; and
a second portion extending from the first portion toward a lower position and connected to the electrode terminals of the first and second battery cells.

15. The battery pack as claimed in claim 5, wherein a connection portion of the 1st-1 bus bar and a connection portion of the 2nd-1 bus bar extend across upper positions of the first and second bus bars, a first portion of a rear connection bar connected to the third bus bar, and a first portion of first and second terminal connecting members including the first and second output terminals are disposed at upper positions of a same level in the second direction.

16. The battery pack as claimed in claim 5, wherein a connection portion of the 1st-2 bus bar and a connection portion of the 2nd-2 bus bar extend across lower positions of the first and second bus bars and are disposed at lower positions of a same level in the second direction.

17. The battery pack as claimed in claim 1, wherein the first and second bus bars are positioned on a pair of side plates extending across the first and second side surfaces of the plurality of battery cells, the side plates covering the first and second side surfaces of the plurality of battery cells, and the first and second bus bars are electrically connected to electrode terminals of the plurality of battery cells, with the electrode terminals being exposed through first and second terminal holes formed in the side plates.

18. The battery pack as claimed in claim 17, further comprising cover pieces in the first and second terminal holes to close a portion of the first and second terminal holes.

19. The battery pack as claimed in claim 18, wherein the cover pieces block the first bus bar and the second bus bar from electrically connecting to a pair of battery cells of the plurality cells that are matched to each other on the first and second side surfaces of the pair of battery cells from being erroneously connected to a battery cell interposed between the pair of the battery cells.

20. The battery pack as claimed in claim 5, wherein a connection portion of the 1st-1 bus bar and a connection portion of the 2nd-1 bus bar extend across upper positions of the first and second bus bars, a first portion of arear connection bar is connected to the third bus bar, and a first portion of first and second terminal connection members includes the first and second output terminals, and the first and second terminal connection members are disposed at an upper position,
wherein the connection portion of the 1 st-2 bus bar and the connection portion of the 2nd-2 bus bar extend across lower positions among the first and second bus bars and are disposed at a lower position in the second direction, and
wherein cover pieces are formed on a lower portion of first and second terminal holes, with the cover pieces extending across the connection portion of the 1 st-2 bus bar and the connection portion of the 2nd-2 bus bar.

21. The battery pack as claimed in claim 5, wherein the 1 st-1 bus bar and the 2nd-1 bus bar include a 1 st-1 connection unit and a 2nd-1 connection unit, respectively, disposed on side plates, the 1 st-1 bus bar and the 2nd-1 bus bar include a pair of 1 st-1 branch portions and a pair of 2nd-1 branch portions, respectively, that are connected to electrode terminals extended from the 1st-1 connection unit and the 2nd-1 connection unit, respectively, the pair of 1 st-1 branch portions and the pair of 2nd-1 branch portions are exposed to outside of the side plates through first and second terminal holes of the side plates, and pair of 1st-1 branch portions and a pair of 2nd-1 branch portions are formed to be stepwise outward from the 1st-1 connection unit or the 2nd-1 connection unit, respectively, and
wherein the 1 st-2 bus bar and the 2nd-2 bus bar include a pair of 1 st-2 branch portions and a pair of 2nd-2 branch portions, respectively, connected to the electrode terminals exposed to the outside of the side plates through the first and second terminal holes of the side plates, and a 1 st-2 connection unit and a 2nd-2 connection unit connect the pair of 1 st-2 branch portions and the pair of 2nd-2 branch portions to each other, respectively, and the 1st-2 connection unit and the 2nd-2 connection unit are formed to be stepwise outward from the pair of 1st-2 branch portions and the pair of 2nd-2 branch portions, respectively to accommodate cover pieces.
